(19) United States
(12) Patent Application Publication
(10) Pub. No.: US 2026/0155730 A1
(43) Pub. Date: Jun. 4, 2026

(54) POWER CONVERSION SYSTEM AND METHOD THEREOF

(71) Applicant: INDUSTRIAL TECHNOLOGY RESEARCH INSTITUTE, Hsinchu (TW)

(72) Inventors: Yeh-Hsiang HO, Chiayi County (TW); Ming-Hung YU, Hsinchu County (TW); Pao-Chuan LIN, Hsinchu County (TW)

(73) Assignee: INDUSTRIAL TECHNOLOGY RESEARCH INSTITUTE, Hsinchu (TW)

(21) Appl. No.: 18/970,604

(22) Filed: Dec. 5, 2024

(30) Foreign Application Priority Data
Nov. 29, 2024 (TW) 113146445

(51) Int. Cl. H02M 1/00; H02M 7/46

(52) U.S. Cl. CPC H02M 1/0048; H02M 1/0009; H02M 1/0012; H02M 7/46

(57) ABSTRACT

A power conversion method includes detecting an output current signal of a power conversion circuit; generating a current adjustment signal according to the output current signal; generating a plurality of control signals according to the current adjustment signal; and outputting a burst signal group to a corresponding power circuit according to one of the control signals to control a plurality of power switches of the corresponding power circuit. The burst signal group includes a plurality of burst signals. Each of the burst signals includes a plurality of burst intervals, and there is a burst spacing between two adjacent ones of the burst intervals. The power circuit operates in a working mode in each of the burst intervals and operates in a rest mode in each of the burst spacings.

### CROSS REFERENCE TO RELATED APPLICATION

This non-provisional application claims priority under 35 U.S.C. § 119 (a) to patent application No. 113146445 filed in Taiwan, R.O.C. on Nov. 29, 2024, the entire contents of which are hereby incorporated by reference.

### TECHNICAL FIELD

The present application relates to technologies of power application such as a power conversion system and a method thereof.

### BACKGROUND

Nowadays, a renewable energy system is gradually emerging, which converts renewable energy (e.g., solar energy or wind power) into an AC power supply and then connects the AC power supply to a utility power. The renewable energy system is generally used for high-power conversion, e.g., power conversion of a megawatt level or above. Therefore, the renewable energy system generally has a plurality of power units to implement high-power conversion. However, due to the larger amount of the power units and since they always operate at a high frequency (e.g., rated switching frequency), a switching loss can be easily caused and the conversion efficiency of the renewable energy system is reduced.

### SUMMARY

The present application provides a power conversion system and a method thereof. The power conversion system includes a power conversion circuit, a current detection circuit, a current adjustment circuit, a control circuit and a plurality of signal generation circuits. The power conversion circuit includes a plurality of power circuits connected in series. Each of the power circuits includes a plurality of power switches. The current detection circuit is coupled to the power conversion circuit, and detects an output current signal of the power conversion circuit. The current adjustment circuit is coupled to the current detection circuit, and generates a current adjustment signal according to the output current signal. The control circuit is coupled to the current adjustment circuit, and generates a plurality of control signals according to the current adjustment signal. Each of the signal generation circuits is coupled between the control circuit and one of the power circuits to output a burst signal group to a corresponding power circuit according to one of the control signals to control the power switches of the corresponding power circuit. The burst signal group includes a plurality of burst signals. Each of the burst signals includes a plurality of burst intervals, and there is a burst spacing between two adjacent ones of the burst intervals. Each of the power circuits operates in a working mode in each of the burst intervals and operates in a rest mode in each of the burst spacings.

A power conversion method includes detecting an output current signal of a power conversion circuit; generating a current adjustment signal according to the output current signal; generating a plurality of control signals according to the current adjustment signal; and outputting a burst signal group to a corresponding power circuit according to one of the control signals to control a plurality of power switches of the corresponding power circuit. The burst signal group includes a plurality of burst signals. Each of the burst signals includes a plurality of burst intervals, and there is a burst spacing between two adjacent ones of the burst intervals. The power circuit operates in a working mode in each of the burst intervals and operates in a rest mode in each of the burst spacings.

According to some embodiments, each of the power circuits operates in the working mode in each of the burst intervals and operates in the rest mode in each of the burst spacings (that is, each of the power circuits operates alternately between the working mode and the rest mode), by which the switching loss of each of the power switches in each of the power circuits can be reduced, thereby improving the overall conversion efficiency of the power conversion system.

### BRIEF DESCRIPTION OF THE DRAWINGS

FIG. 1 is a block schematic diagram of a power conversion system according to some embodiments of the present application.

FIG. 2 is a detailed circuit schematic diagram of a single power circuit according to some embodiments of the present application.

FIG. 3 is a flowchart of a power conversion method according to some embodiments of the present application.

FIG. 4 is a detailed schematic diagram of a signal generation circuit according to some embodiments of the present application.

FIG. 5 is a schematic diagram of a burst signal according to some embodiments of the present application.

FIG. 6 is a schematic diagram of a first burst signal to a fourth burst signal, a current adjustment signal and a first control signal of a first burst signal group according to a first embodiment of the present application.

FIG. 7 is a schematic diagram of a fifth burst signal to an eighth burst signal, a current adjustment signal and a second control signal of a second burst signal group according to a first embodiment of the present application.

FIG. 8 is a schematic diagram of a ninth burst signal to a twelfth burst signal, a current adjustment signal and a third control signal of a third burst signal group according to a first embodiment of the present application.

FIG. 9 is a schematic diagram of a thirteenth burst signal to a sixteenth burst signal, a current adjustment signal and a fourth control signal of a fourth burst signal group according to a first embodiment of the present application.

FIG. 10 is a schematic diagram of a certain burst signal in a first burst signal group, a certain burst signal in a second burst signal group, a certain burst signal in a third burst signal group, a certain burst signal in a fourth burst signal group and a current adjustment signal according to a second embodiment of the present application.

### DETAILED DESCRIPTION

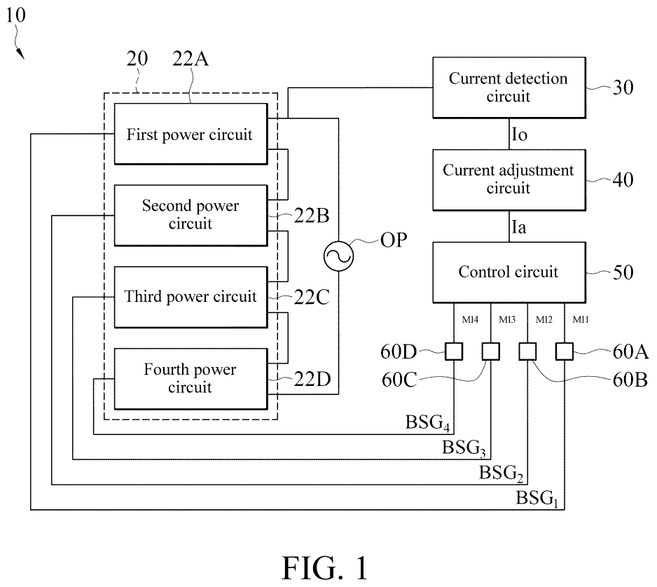

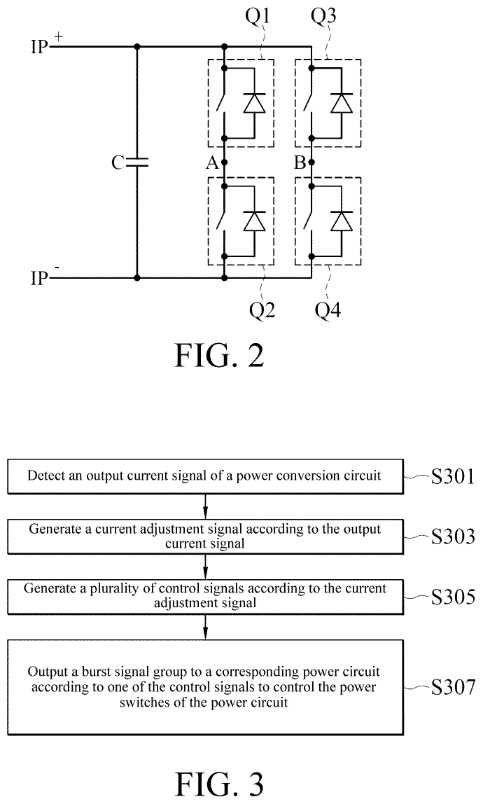

References are made to FIGS. 1 and 2. FIG. 1 is a block schematic diagram of a power conversion system 10 according to some embodiments of the present application. FIG. 2 is a detailed circuit schematic diagram of a single power circuit according to some embodiments of the present application. The power conversion system 10 includes a power conversion circuit 20, a current detection circuit 30, a current adjustment circuit 40, a control circuit 50 and a plurality of signal generation circuits. The current detection circuit 30 is coupled to the power conversion circuit 20. The current adjustment circuit 40 is coupled to the current detection circuit 30. The control circuit 50 is coupled to the current adjustment circuit 40. The current detection circuit 30 is, for example, a circuit for detecting current that is formed by passive components such as a resistor, a capacitor, and an inductor, and/or active components such as a transistor. The current adjustment circuit 40 is, for example, an application-specific integrated circuit (ASIC). The control circuit 50 is, for example, a microprocessor. In some embodiments, the current adjustment circuit 40 and the control circuit 50 can be integrated into a single operational circuit, e.g., a single-chip microcomputer or a field programmable gate array (FPGA) apparatus.

As shown in FIG. 1, the power conversion circuit 20 includes a plurality of power circuits connected in series to convert an input source IP (as shown in FIG. 2) into an output source OP. The input source IP is, for example, a DC power supply, which can be converted from renewable energy. The output source OP is, for example, an AC power supply. FIG. 1 illustrates here four signal generation circuits (e.g., a first signal generation circuit 60A, a second signal generation circuit 60B, a third signal generation circuit 60C, and a fourth signal generation circuit 60D) and four power circuits (e.g., a first power circuit 22A, a second power circuit 22B, a third power circuit 22C, and a fourth power circuit 22D). But the present application is not limited to this. The amount of the signal generation circuits and the amount of the power circuits can be adjusted according to the needs of users and correspond to each other. Each of the signal generation circuits is coupled between the control circuit 50 and one of the power circuits. For example, the first signal generation circuit 60A is coupled between the control circuit 50 and the first power circuit 22A, the second signal generation circuit 60B is coupled between the control circuit 50 and the second power circuit 22B, and so on.

As shown in FIG. 2, each power circuit includes a plurality of power switches and a capacitor C. In some embodiments, each power circuit is a bridge circuit. FIG. 2 illustrates here four power switches (e.g., a first power switch Q1, a second power switch Q2, a third power switch Q3, and a fourth power switch Q4). But the present application is not limited to this. The amount of the power switches can be adjusted according to the needs of users. The bridge circuit will be illustrated below taking four power switches as examples. The first power switch Q1 is connected in series with the second power switch Q2 to form a first series circuit, and the third power switch Q3 is connected in series with the fourth power switch Q4 to form a second series circuit. The first series circuit, the second series circuit, the capacitor C, and the input source IP are connected in parallel. Node A between the first power switch Q1 and the second power switch Q2, and Node B between the third power switch Q3 and the fourth power switch Q4 form an output side of the power circuit. As such, the power circuit forms the bridge circuit. Furthermore, the output sides of all the power switches are connected in series to generate the output source OP (as shown in FIG. 1). Specifically, the node A between the first power switch Q1 and the second power switch Q2 is an output terminal of the power circuit, and the node B between the third power switch Q3 and the fourth power switch Q4 is another output terminal of the power circuit. One of the two output terminals of a certain power switch is coupled to one of the two output terminals of another power switch, thereby forming a series connection relationship of the output sides of all the power circuits.

References are made to FIGS. 1 and 3. FIG. 3 is a flowchart of a power conversion method according to some embodiments of the present application. The power conversion system 10 is adapted to implement the power conversion method of the present application. Firstly, a current detection circuit 30 detects an output current signal Iₒ of a power conversion circuit 20 (step S301). The output current signal Iₒ is a current signal of an output source OP. Next, a current adjustment circuit 40 generates a current adjustment signal Iₐ according to the output current signal Iₒ (step S303). Next, a control circuit 50 generates a plurality of control signals according to the current adjustment signal Iₐ (step S305). FIG. 1 illustrates here four control signals (e.g., a first control signal MI1, a second control signal MI2, a third control signal MI3, and a fourth control signal MI4). But the present application is not limited to this. The amount of the control signals can be adjusted according to the needs of users and correspond to the amount of signal generation circuits and the amount of power circuits. These control signals (MI1-MI4) are provided to signal generation circuits (60A-60D) in a one-to-one correspondence manner.

Next, each of the signal generation circuits outputs a burst signal group (e.g., a first burst signal group BSG₁, a second burst signal group BSG₂, a third burst signal group BSG₃, or a fourth burst signal group BSG₄) to a corresponding power circuit according to one of the control signals (i.e., the acquired control signal) to control the power switches of the corresponding power circuit (step S307). For example, as shown in FIG. 1, the first signal generation circuit 60A outputs the first burst signal group BSG₁ to the first power circuit 22A according to the first control signal MI1 to control the power switches of the first power circuit 22A (the first power switch Q1 to the fourth power switch Q4 as shown in FIG. 2). The second signal generation circuit 60B outputs the second burst signal group BSG₂ to the second power circuit 22B according to the second control signal MI2 to control the power switches of the second power circuit 22B (the first power switch Q1 to the fourth power switch Q4 as shown in FIG. 2), and so on.

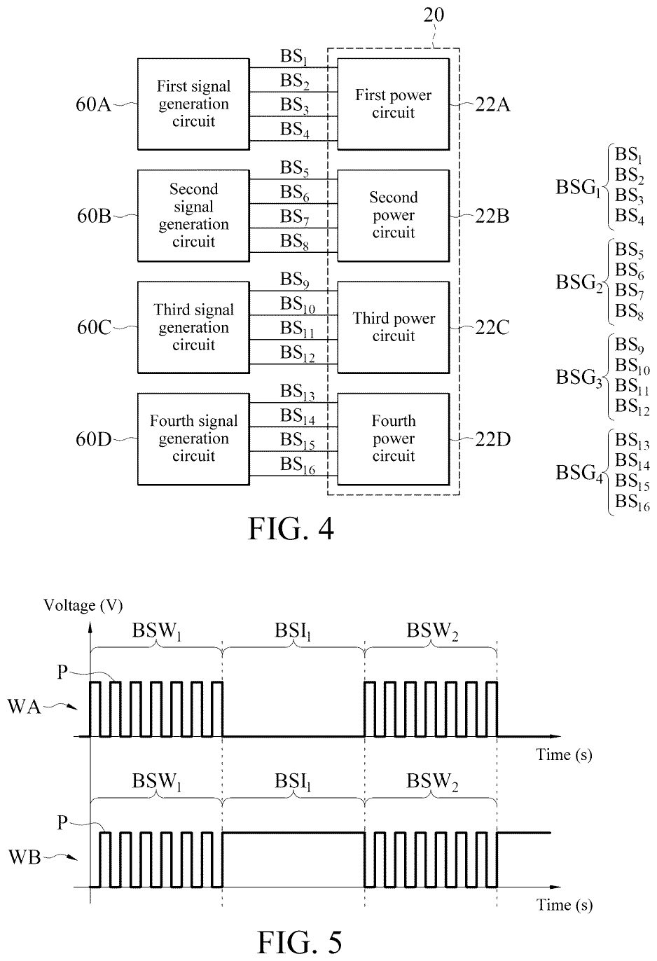

Referring to FIG. 4, a detailed schematic diagram of a signal generation circuit according to some embodiments of the present application. Each burst signal group includes a plurality of burst signals (e.g., a first burst signal BS₁ to a fourth burst signal BS₄, a fifth burst signal BS₅ to an eighth burst signal BS₈, a ninth burst signal BS₉ to a twelfth burst signal BS₁₂, or a thirteenth burst signal BS₁₃ to a sixteenth burst signal BS₁₆) to control the power switches in the corresponding power circuits respectively. For example, the first burst signal group BSG₁ includes the first burst signal BS₁ to the fourth burst signal BS₄ to control the power switches in the first power circuit 22A (the first power switch Q1 to the fourth power switch Q4 as shown in FIG. 2) respectively. The second burst signal group BSG₂ includes the fifth burst signal group BS₅ to the eighth burst signal group BS₈ to control the power switches in the second power circuit 22B (the first power switch Q1 to the fourth power switch Q4 as shown in FIG. 2) respectively, and so on. FIG. 4 illustrates here that each burst signal group includes four burst signals. But the present application is not limited to this. The amount of the burst signals included in each burst signal group can be adjusted according to the needs of users and corresponds to the amount of the power switches in the corresponding power circuit

Referring to FIG. 5, a schematic diagram of a burst signal according to some embodiments of the present application. A waveform WA is an example of the burst signal, and a waveform WB is another example of the burst signal. Each burst signal includes a plurality of burst intervals, and there is a burst spacing (e.g., a first burst spacing BSI₁) between two adjacent ones of the burst intervals (e.g., between a first burst interval BSW₁ and a second burst interval BSW₂). In some embodiments, each burst interval includes a plurality of pulses P, and each burst spacing does not have the pulses P. That is, the burst interval refers to a time period (also referred to as a phase interval) in which the burst signal includes the pulses P (specifically, continuous pulses), that is, in the burst interval, the burst signal is a pulse width modulation signal. The burst spacing refers to a time period (also referred to as the phase interval) in which the burst signal does not have the pulses P, that is, in the burst spacing, the burst signal is a level signal (e.g., a low-level signal as shown in the waveform WA or a high-level signal as shown in the waveform WB in FIG. 5).

Each power circuit operates in a working mode in the burst interval and operates in a rest mode in the burst spacing. Specifically, the power switches in each power circuit (the first power switch Q1 to the fourth power switch Q4 as shown in FIG. 2) are controlled by the corresponding burst signals, and are repeatedly switched between an on state and an off state at a rated switching frequency in the burst interval, so that the power circuit operates in the working mode. The power switches in each power circuit are controlled by the corresponding burst signals, and are maintained in the on state or off state in the burst spacing, so that the power circuit operates in the rest mode. In other words, compared to the rest mode, the working mode allows the power circuit to operate in a high-frequency state. Compared to the working mode, the rest mode allows the power circuit to operate in a low-frequency state. In some embodiments, when the burst signal is at a low level, the power switch controlled by the burst signal is in the off state, and when the burst signal is at a high level, the power switch controlled by the burst signal is in the on state. But the present application is not limited to this. When the burst signal is at the low level, the power switch controlled by the burst signal is in the on state, and when the burst signal is at the high level, the power switch controlled by the burst signal is in the off state.

As such, each of the power circuits operates alternately between the working mode (high-frequency state) and the rest mode (low-frequency state), by which each of the power circuits being always in the high-frequency state can be avoided, thereby reducing the switching loss of each of the power switches in each of the power circuits and improving the overall conversion efficiency of the power conversion system 10. Specifically, in a comparative example of a power conversion system using phase shift modulation, the operation of the power switch is controlled by the phase shift modulation. At this time, the power switch is always in the high-frequency state, that is, the power switch is repeatedly switched between the on state and off state at the rated switching frequency. Since the power switch of the present application according to some embodiments does not need to be always in the high-frequency state, the switching loss can be reduced by at least 33% and the overall conversion efficiency of the power conversion system 10 can be improved in comparison with those of the comparative example. For example, at the switching frequency of 3.48 kHz, the switching loss and converter efficiency of the comparative example are 2500 watts and 98.94% respectively, while the switching loss and converter efficiency of the present application according to some embodiments are 825 watts and 99.22% respectively.

In some embodiments, the time length (also referred to as a phase interval length) of the burst interval and the time length (also referred to as the phase interval length) of the burst spacing of the burst signal are the same within a single cycle, so that each of the power circuits has consistent heat dissipation requirements in both the working mode and the rest mode, thus facilitating subsequent applications for the users. But the present application is not limited to this. In some other embodiments, the time length of the burst interval and the time length of the burst spacing of the burst signal are different within a single cycle.

In some embodiments, the current adjustment circuit 40 generates a current adjustment signal Iₐ with a current boost message when the current adjustment circuit 40 determines that the output current signal Iₒ meets a current boost condition. For example, when the output current signal Iₒ is less than a output current threshold, it indicates that the output current signal Iₒ meets the current boost condition, and the current adjustment circuit 40 generates the current boost message according to a difference between the output current signal Iₒ and the output current threshold and puts the current boost message into the current adjustment signal Iₐ. The control circuit 50 increases amplitudes of the control signals according to the current boost message. Each of the signal generation circuits increases a pulse duty cycle of the pulses P in each of the burst interval according to each of the control signals with the increased amplitudes, in order to increase the output current signal Iₒ of the power conversion circuit 20 to the output current threshold. As such, the output current signal Iₒ of the power conversion circuit 20 can be maintained at a specific value, thereby sink/source the output (i.e., the output source OP) of the power conversion system 10.

In some embodiments, the current adjustment circuit 40 generates a current adjustment signal Iₐ with a current drop message when the current adjustment circuit 40 determines that the output current signal Iₒ meets a current drop condition. For example, when the output current signal Iₒ is greater than a output current threshold, it indicates that the output current signal Iₒ meets the current drop condition, and the current adjustment circuit 40 generates the current drop message according to a difference between the output current signal Iₒ and the output current threshold and puts the current drop message into the current adjustment signal Iₐ. The control circuit 50 decreases the amplitudes of the control signals according to the current drop message. Each of the signal generation circuits reduces a pulse duty cycle of the pulses P in each of the burst interval according to each of the control signals with the decreased amplitudes, in order to decrease the output current signal Iₒ of the power conversion circuit 20 to the output current threshold. As such, the output current signal Iₒ of the power conversion circuit 20 can be maintained at a specific value, thereby sink/source the output (i.e., the output source OP) of the power conversion system 10.

In some embodiments, each of the signal generation circuits triggers each of the burst intervals of each of the burst signals in a corresponding burst signal group according to a working transition angle, and triggers each of the burst spacings of each of the burst signals in the corresponding burst signal groups according to a rest transition angle. The working transition angle and the rest transition angle are each phase angles of a signal within a single cycle and are different from each other. As such, it can be ensured that each of the power circuits operates alternately between the working mode and the rest mode. In some embodiments, the working transition angle and the rest transition angle are calculated by the control circuit 50 and stored for use by each of the signal generation circuits. In some other embodiments, the working transition angle and the rest transition angle are inputted to the control circuit 50 by the user via an electronic apparatus and stored for use by each of the signal generation circuits.

In some embodiments, each of the burst signal groups corresponds to a different working transition angle, and each of the burst signal groups corresponds to a different rest transition angle. Furthermore, each of the burst signals in the same burst signal group corresponds to the same working transition angle, and each of the burst signals in the same burst signal group corresponds to the same rest transition angle. As such, the problem that the heat dissipation demand is increased due to the fact that many power circuits in the power conversion system 10 are in working mode at the same time is avoided. It will be illustrated below with two embodiments.

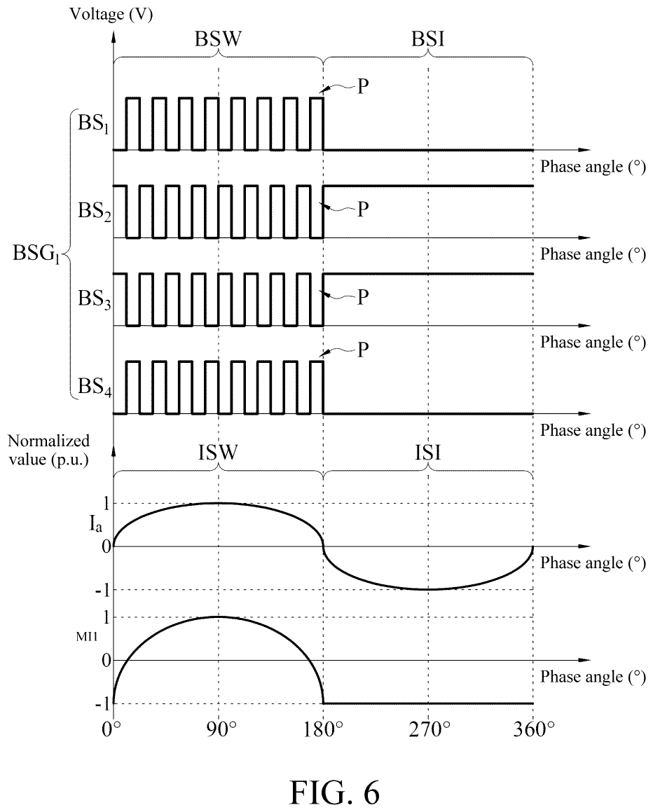

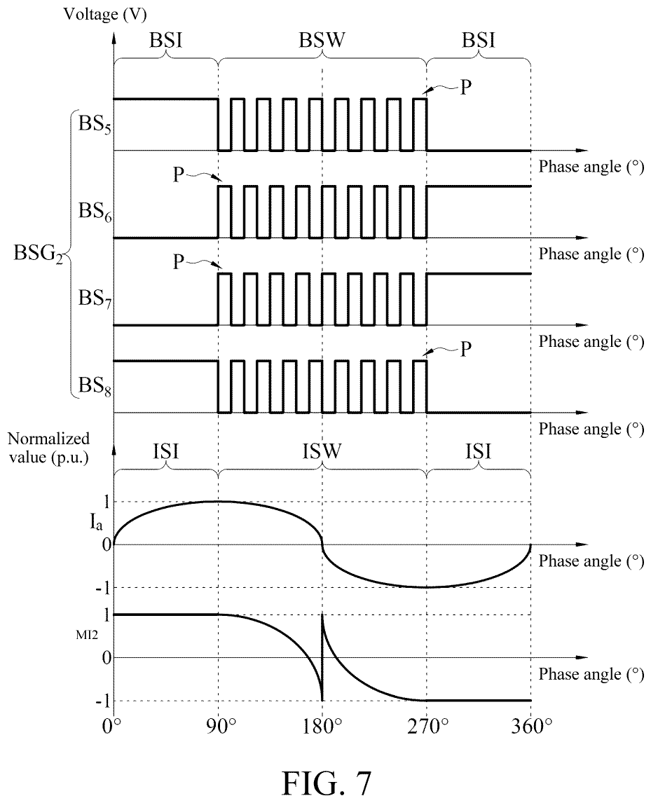

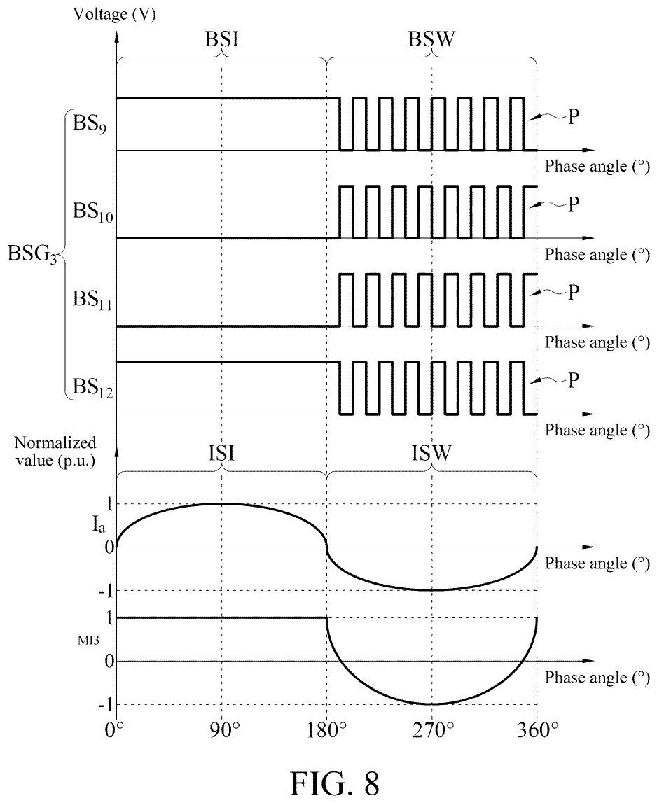

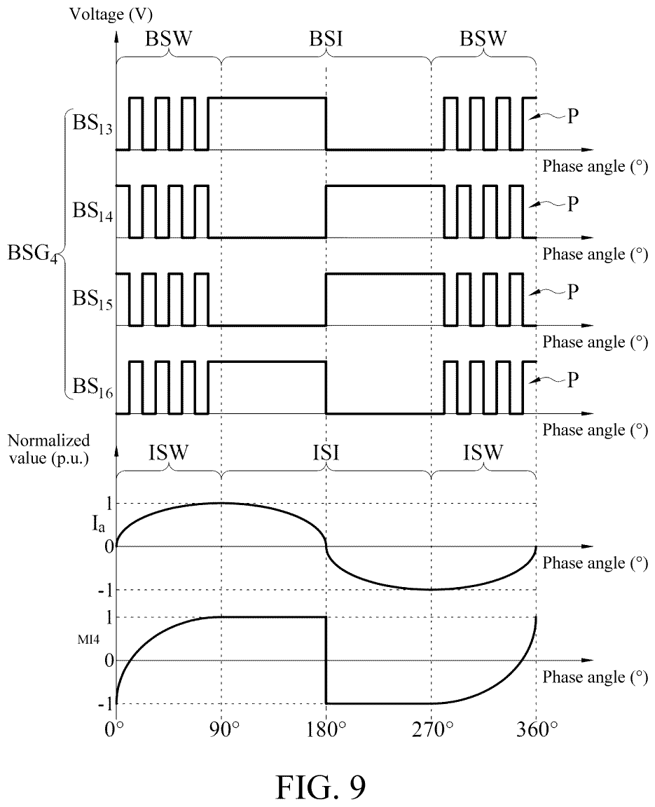

References are made to FIGS. 6 through 9. FIG. 6 is a schematic diagram of a first burst signal BS₁ to a fourth burst signal BS₄, a current adjustment signal Iₐ and a first control signal MI1 of a first burst signal group BSG₁ according to a first embodiment of the present application. FIG. 7 is a schematic diagram of a fifth burst signal BS₅ to an eighth burst signal BS₈, a current adjustment signal Iₐ and a second control signal MI2 of a second burst signal group BSG₂ according to a first embodiment of the present application. FIG. 8 is a schematic diagram of a ninth burst signal BS₉ to a twelfth burst signal BS₁₂, a current adjustment signal Iₐ and a third control signal MI3 of a third burst signal group BSG₃ according to a first embodiment of the present application. FIG. 9 is a schematic diagram of a thirteenth burst signal BS₁₃ to a sixteenth burst signal BS₁₆, a current adjustment signal Iₐ and a fourth control signal MI4 of a fourth burst signal group BSG₄ according to a first embodiment of the present application. In FIGS. 6 through 9, the time period (also referred to as the phase interval) in which the burst signal has the pulses P therein refers to a burst interval BSW, and the time period (also referred to as the phase interval) in which the burst signal does not have the pulses P therein refers to a burst spacing BSI. It can be seen from FIGS. 6 through 9 that in the first embodiment, the working transition angle corresponding to the first burst signal group BSG₁ and its first burst signal BS₁ to its fourth burst signal BS₄ is) 0° (360° and the rest transition angle corresponding to the first burst signal group BSG₁ and its first burst signal BS₁ to its fourth burst signal BS₄ is 180°; the working transition angle corresponding to the second burst signal group BSG₂ and its fifth burst signal BS₅ to its eighth burst signal BS₈ is 90° and the rest transition angle corresponding to the second burst signal group BSG₂ and its fifth burst signal BS₅ to its eighth burst signal BS₈ is 270°; the working transition angle corresponding to the third burst signal group BSG₃ and its ninth burst signal BS₉ to its twelfth burst signal BS₁₂ is 180° and the rest transition angle corresponding to the third burst signal group BSG₃ and its ninth burst signal BS₉ to its twelfth burst signal BS₁₂ is) 0° (360°; and the working transition angle corresponding to the fourth burst signal group BSG₄ and its thirteenth burst signal BS₁₃ to its sixteenth burst signal BS₁₆ is 270° and the rest transition angle corresponding to the fourth burst signal group BSG₄ and its thirteenth burst signal BS₁₃ to its sixteenth burst signal BS₁₆ is 90°.

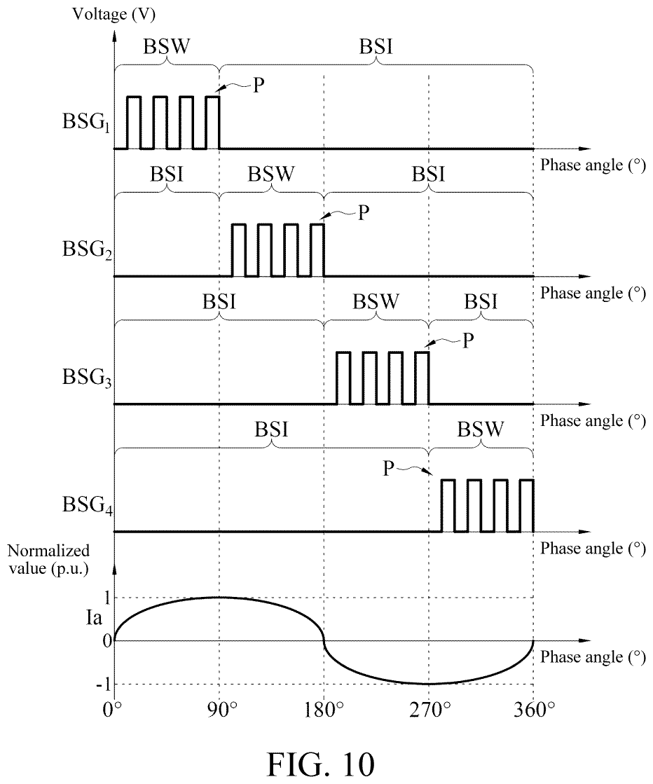

Referring to FIG. 10, a schematic diagram of a certain burst signal in a first burst signal group BSG₁, a certain burst signal in a second burst signal group BSG₂, a certain burst signal in a third burst signal group BSG₃, a certain burst signal in a fourth burst signal group BSG₄ and a current adjustment signal Iₐ according to a second embodiment of the present application. In FIG. 10, the time period (also referred to as the phase interval) in which the burst signal has the pulses P therein refers to a burst interval BSW, and the time period (also referred to as the phase interval) in which the burst signal does not have the pulses P therein refers to a burst spacing BSI. For the sake of simplicity, only one burst signal is illustrated in each burst signal group here. Since each of the burst signals in the same burst signal group corresponds to the same working transition angle, and each of the burst signals in the same burst signal group corresponds to the same rest transition angle, it can be seen from FIG. 10 that in the second embodiment, the working transition angle corresponding to the first burst signal group BSG₁ (and its first burst signal BS₁ to its fourth burst signal BS₄) is 0° (360°) and the rest transition angle corresponding to the first burst signal group BSG₁ (and its first burst signal BS₁ to its fourth burst signal BS₄) is 180°; the working transition angle corresponding to the second burst signal group BSG₂ (and its fifth burst signal BS₅ to its eighth burst signal BS₈) is 90° and the rest transition angle corresponding to the second burst signal group BSG₂ (and its fifth burst signal BS₅ to its eighth burst signal BS₈) is 270°; the working transition angle corresponding to the third burst signal group BSG₃ (and its ninth burst signal BS₉ to its twelfth burst signal BS₁₂) is 180° and the rest transition angle corresponding to the third burst signal group BSG₃ (and its ninth burst signal BS₉ to its twelfth burst signal BS₁₂) is 0° (360°); and the working transition angle corresponding to the fourth burst signal group BSG₄ (and its thirteenth burst signal BS₁₃ to its sixteenth burst signal BS₁₆) is 270° and the rest transition angle corresponding to the fourth burst signal group BSG₄ (and its thirteenth burst signal BS₁₃ to its sixteenth burst signal BS₁₆) is 90°.

In some embodiments, there is a linear relationship between the rest transition angle and the working transition angle corresponding to the same burst signal group. For example, the relationship between the rest transition angle and the working transition angle can be expressed by Equation 1, where γₙ is a rest transition angle, βₙ is a working transition angle, and d is a translation amount. In the aforementioned first embodiment, the translation amount is 180°, and at this time, it is possible to make the time length (also referred to as the phase interval length) of the burst interval of the burst signal the same as the time length (also referred to as the phase interval length) of the burst spacing within a single cycle. In the aforementioned second embodiment, the translation amount is 90°, and at this time, it is possible to make the time length of the burst interval of the burst signal be different from the time length of the burst spacing within a single cycle. For example, the time length of the burst interval of the burst signal is shorter than the time length of the burst spacing within a single cycle. In some other embodiments, the translation amount is 270°, so that the time length of the burst interval of the burst signal is longer than the time length of the burst spacing within a single cycle. n is the serial number of the burst signal group, for example, the serial number of the first burst signal group BSG₁ is 1, the serial number of the second burst signal group BSG₂ is 2, and so on. As such, it can be ensured that there is a correlation between the time length of the burst interval and the time length of the burst spacing, for example, the time length of the burst interval and the time length of the burst spacing complement each other within a single cycle to meet the heat dissipation needs of the power conversion system 10.

$${γ}_{n} = {β}_{n} + d \qquad ( Equation 1 )$$

In some embodiments, the translation amount is a constant. As shown in Equation 2, d is the translation amount, and ct is a constant. In some other embodiments, the translation amount is a multiple of a transition differentiation angle. As shown in Equation 3, d is the translation amount, a is the transition differentiation angle, and m is a multiple value.

$$d = ct \qquad ( Equation 2 )$$

$$d = m α \qquad ( Equation 3 )$$

In some embodiments, the transition differentiation angle is a ratio between a cycle total phase angle and the amount of the power circuits. As shown in Equation 4, α is the transition differentiation angle, ta is the cycle total phase angle and is 360°, and PN is the amount of the power circuits. For example, assuming the amount of the power circuits is four, the transition differentiation angle is 90°.

$$α = \frac{ta}{PN} \qquad ( Equation 4 )$$

In some embodiments, the working transition angle is proportional to the transition differentiation angle. For example, the working transition angle is directly proportional to the transition differentiation angle. As shown in Equation 5, βₙ is the working transition angle, α is the transition differentiation angle, and n is the serial number of the burst signal groups.

$${β}_{n} = α ( n - 1 ) \qquad ( Equation 5 )$$

As shown in FIGS. 6 through 9, in some embodiments, each of the control signals includes a plurality of control intervals ISWs, and there is a control spacing ISI between two adjacent ones of the control intervals ISWs. In the control signal and the burst signal group corresponding to the same power circuit, each of the control intervals ISWs corresponds to each of the burst intervals BSWs of each of the burst signals. In the control signal and the burst signal group corresponding to the same power circuit, each of the control spacings ISIs corresponds to each of the burst spacings BSIs of each of the burst signals. For example, the first control signal MI1 and the first burst signal group BSG₁ both correspond to the first power circuit 22A, and the phase interval (i.e., the range between a phase start point and a phase end point) of the control interval ISW of the first control signal MI1 within a single cycle is the same as that of the burst intervals BSWs of the first burst signal BS₁ to the fourth burst signal BS₄ in the first burst signal group BSG₁ within a single cycle; the phase interval of the control spacing ISI of the first control signal MI1 within a single cycle is the same as that of the burst spacings BSIs of the first burst signal BS₁ to the fourth burst signal BS₄ in the first burst signal group BSG₁ within a single cycle; the second control signal MI2 and the second burst signal group BSG₂ both correspond to the second power circuit 22B, and the phase interval of the control interval ISW of the second control signal MI2 within a single cycle is the same as that of the burst intervals BSWs of the fifth burst signal BS₅ to the eighth burst signal BS₈ in the second burst signal group BSG₂ within a single cycle; and the phase interval of the control spacing ISI of the second control signal MI2 within a single cycle is the same as that of the burst spacings BSIs of the fifth burst signal BS₅ to the eighth burst signal BS₈ in the second burst signal group BSG₂ within a single cycle, and so on.

As shown in FIGS. 6 through 9, in some embodiments, the signal within each of the control intervals ISWs is generated after the control circuit 50 performs level averaging on a corresponding signal segment of the current adjustment signal Iₐ. The level averaging is, for example, to perform linear conversion on the corresponding signal segment of the current adjustment signal Iₐ to normalize the range of the corresponding signal segment, and allow the normalized signal segment to serve as the signal within the control interval ISW of the control signal. For example, as shown in FIG. 6, the range of the signal segment of the current adjustment signal Iₐ corresponding to the control interval ISW is from 0 p.u. (per unit) to 1 p.u . . . . The control circuit 50 performs linear conversion on the signal segment according to Equation 6 to normalize the range of the signal segment to −1 p.u. to 1 p.u., and allow the normalized signal segment as the signal within the control interval ISW of the control signal. As shown in FIG. 8, the range of the signal segment of the current adjustment signal Iₐ corresponding to the control interval ISW is from −1 p.u. to 0 p.u . . . . The control circuit 50 performs linear conversion on the signal segment according to Equation 7 to normalize the range of the signal segment to −1 p.u. to 1 p.u., and allow the normalized signal segment to serve as the signal within the control interval ISW of the control signal. y is a signal value of the control signal, and x is a signal value of the current adjustment signal Iₐ. By the normalized signal range, it is possible to facilitate the use of each control signal by each signal generation circuit for subsequent processing.

$$y = 2 x - 1 \qquad ( Equation 6 )$$

$$y = 2 x + 1 \qquad ( Equation 7 )$$

As shown in FIGS. 6 through 9, in some embodiments, the signal within each of the control spacings ISIs is a level signal generated by the control circuit 50 using the corresponding signal segment of the current adjustment signal Iₐ. For example, the control circuit 50 allows a low-level signal to serve as the signal within the control spacing ISI of the control signal when the control circuit 50 determines that the signal segment of the current adjustment signal Iₐ corresponding to the control spacing ISI meets a low-level condition. The low-level condition is, for example, that the signal segment of the current adjustment signal Iₐ corresponding to the control spacing ISI is in a negative half cycle or less than 0 p.u . . . . As shown in FIG. 6, since the signal segment of the current adjustment signal Iₐ corresponding to the control spacing ISI is in the negative half cycle and is less than 0 p.u., the control circuit 50 allows the signal at the level of −1 p.u. to serve as the signal within the control spacing ISI of the control signal. The control circuit 50 allows a high-level signal to serve as the signal within the control spacing ISI of the control signal when the control circuit 50 determines that the signal segment of the current adjustment signal Iₐ corresponding to the control spacing ISI meets a high-level condition. The high-level condition is, for example, that the signal segment of the current adjustment signal Iₐ corresponding to the control spacing ISI is in a positive half cycle or greater than the 0 p.u . . . . As shown in FIG. 8, since the signal segment of the current adjustment signal Iₐ corresponding to the control spacing ISI is in the positive half cycle and is greater than 0 p.u., the control circuit 50 allows the signal at the level of the 1 p.u. to serve as the signal within the control spacing ISI of the control signal.

In some embodiments, the present is adapted to a single-phase power system. But the present application is not limited to this. In some other embodiments, the present application is applied to a three-phase power system. Specifically, the power conversion system 10 includes three single-phase power conversion systems, for use in R-phase, S-phase, and T-phase of the three-phase power system, and each single-phase power conversion system includes the aforementioned power conversion circuit 20, current detection circuit 30, current adjustment circuit 40, control circuit 50, and signal generation circuits to achieve the aforementioned operation.

According to some embodiments, each of the power circuits operates in the working mode in each of the burst intervals and operates in the rest mode in each of the burst spacings (that is, each of the power circuits operates alternately between the working mode and the rest mode), by which the switching loss of each of the power switches in each of the power circuits can be reduced, thereby improving the overall conversion efficiency of the power conversion system.

What is claimed is:

1. A power conversion system, comprising:
a power conversion circuit, comprising a plurality of power circuits connected in series, each of the power circuits comprising a plurality of power switches;
a current detection circuit, coupled to the power conversion circuit, and detecting an output current signal of the power conversion circuit;
a current adjustment circuit, coupled to the current detection circuit, and generating a current adjustment signal according to the output current signal;
a control circuit, coupled to the current adjustment circuit, and generating a plurality of control signals according to the current adjustment signal; and
a plurality of signal generation circuits, wherein each of the signal generation circuits is coupled between the control circuit and one of the power circuits to output a burst signal group to a corresponding power circuit according to one of the control signals to control the power switches of the corresponding power circuit, and the burst signal group comprises a plurality of burst signals; each of the burst signals comprises a plurality of burst intervals, and there is a burst spacing between two adjacent ones of the burst intervals; and each of the power circuits operates in a working mode in each of the burst intervals and operates in a rest mode in each of the burst spacings.

2. The power conversion system according to claim 1, wherein each of the burst intervals of each of the burst signals comprises a plurality of pulses; the current adjustment circuit generates the current adjustment signal with a current boost message when the current adjustment circuit determines that the output current signal meets a current boost condition; and the control circuit increases amplitudes of the control signals according to the current boost message, and each of the signal generation circuits increases a pulse duty cycle of the pulses in each of the burst intervals according to each of the control signals with the increased amplitudes to boost the output current signal of the power conversion circuit.

3. The power conversion system according to claim 1, wherein each of the burst intervals of each of the burst signals comprises a plurality of pulses; the current adjustment circuit generates the current adjustment signal with a current drop message when the current adjustment circuit determines that the output current signal meets a current drop condition; and the control circuit decreases amplitudes of the control signals according to the current drop message, and each of the signal generation circuits reduces a pulse duty cycle of the pulses in each of the burst intervals according to each of the control signals with the decreased amplitudes to decrease the output current signal of the power conversion circuit.

4. The power conversion system according to claim 1, wherein each of the signal generation circuits triggers each of the burst intervals of each of the burst signals in a corresponding burst signal group according to a working transition angle, and triggers each of the burst spacings of each of the burst signals in the corresponding burst signal groups according to a rest transition angle.

5. The power conversion system according to claim 4, wherein each of the burst signal groups corresponds to a different working transition angle and a different rest transition angle.

6. The power conversion system according to claim 4, wherein there is a linear relationship between the rest transition angle and the working transition angle.

7. The power conversion system according to claim 6, wherein a translation amount of the linear relationship is a multiple of a transition differentiation angle.

8. The power conversion system according to claim 4, wherein the working transition angle is proportional to a transition differentiation angle.

9. The power conversion system according to claim 8, wherein the transition differentiation angle is a ratio between a cycle total phase angle and the amount of the power circuits.

10. The power conversion system according to claim 7, wherein the transition differentiation angle is a ratio between a cycle total phase angle and the amount of the power circuits.

11. The power conversion system according to claim 1, wherein each of the control signals comprises a plurality of control intervals, and there is a control spacing between two adjacent ones of the control intervals; in the control signal and the burst signal group corresponding to the same power circuit, each of the control intervals corresponds to each of the burst intervals of each of the burst signals, and in the control signal and the burst signal group corresponding to the same power circuit, each of the control spacings corresponds to each of the burst spacings of each of the burst signals; and each of the control intervals is generated after the control circuit performs level averaging on a corresponding signal segment of the current adjustment signal, and each of the control spacings is a level signal generated by the control circuit using a corresponding signal segment of the current adjustment signal.

12. A power conversion method, comprising:
detecting an output current signal of a power conversion circuit;
generating a current adjustment signal according to the output current signal;
generating a plurality of control signals according to the current adjustment signal; and
outputting a burst signal group to a corresponding power circuit according to one of the control signals to control a plurality of power switches of the corresponding power circuit,
wherein the burst signal group comprises a plurality of burst signals; each of the burst signals comprises a plurality of burst intervals, and there is a burst spacing between two adjacent ones of the burst intervals; and the power circuit operates in a working mode in each of the burst intervals and operates in a rest mode in each of the burst spacings.

13. The power conversion method according to claim 12, wherein each of the burst intervals of each of the burst signals comprises a plurality of pulses; the current adjustment signal with a current boost message is generated when it is determined that the output current signal meets a current boost condition; and amplitudes of the control signals are increased according to the current boost message, and a pulse duty cycle of the pulses in each of the burst intervals is increased according to each of the control signals with the increased amplitudes to boost the output current signal of the power conversion circuit.

14. The power conversion method according to claim 12, wherein each of the burst intervals of each of the burst signals comprises a plurality of pulses; the current adjustment signal with a current drop message is generated when it is determined that the output current signal meets a current drop condition; and amplitudes of the control signals are decreased according to the current drop message, and a pulse duty cycle of the pulses in each of the burst intervals is reduced according to each of the control signals with the decreased amplitudes to decrease the output current signal of the power conversion circuit.

15. The power conversion method according to claim 12, wherein each of the burst intervals of each of the burst signals in the burst signal group is triggered according to a working transition angle, and each of the burst spacings of each of the burst signals in the burst signal groups is triggered according to a rest transition angle.

16. The power conversion method according to claim 15, wherein a different burst signal group corresponds to a different working transition angle and a different rest transition angle.

17. The power conversion method according to claim 15, wherein there is a linear relationship between the rest transition angle and the working transition angle.

18. The power conversion method according to claim 17, wherein a translation amount of the linear relationship is a multiple of a transition differentiation angle.

19. The power conversion method according to claim 15, wherein the working transition angle is proportional to a transition differentiation angle.

20. The power conversion method according to claim 19, wherein the transition differentiation angle is a ratio between a cycle total phase angle and the amount of the power circuits.

21. The power conversion method according to claim 18, wherein the transition differentiation angle is a ratio between a cycle total phase angle and the amount of the power circuits.

22. The power conversion method according to claim 12, wherein each of the control signals comprises a plurality of control intervals, and there is a control spacing between two adjacent ones of the control intervals; in the control signal and the burst signal group corresponding to the same power circuit, each of the control intervals corresponds to each of the burst intervals of each of the burst signals, and in the control signal and the burst signal group corresponding to the same power circuit, each of the control spacings corresponds to each of the burst spacings of each of the burst signals; and each of the control intervals is generated after level averaging is performed on a corresponding signal segment of the current adjustment signal, and each of the control spacings is a level signal generated by using a corresponding signal segment of the current adjustment signal.
